(19) United States
(12) Patent Application Publication
(10) Pub. No.: US 2008/0094025 A1
(43) Pub. Date: Apr. 24, 2008

(54) Solar cells on portable devices

(76) Inventors: Michael N. Rosenblatt, Mountain View, CA (US); Christopher David Prest, Mountain View, CA (US); Fletcher Rothkopf, Mountain View, CA (US); Aaron Leiba, San Francisco, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/584,073

(22) Filed: Oct. 20, 2006

(51) Int. Cl. H02J 7/00

(52) U.S. Cl. 320/101

(57) ABSTRACT

Solar cells are integrated into a portable device. Multiple cells are arranged on the surface of the device such that a number of solar cells may always be functional and produce a desired voltage even if the rest is obstructed. Information regarding solar cells' functions or performances can be displayed either on the device's main display or on top of the solar cells. Solar cells are typically stacked with other layers made of transparent or semi-transparent materials. These layers are glued with shock absorbent materials. Some of these layers may be used for display or input purposes, and some layers may be coated with various materials or they may be etched with product logos or other patterns. This stack of layers may be attached to the device's frame through a shock absorber.

### BACKGROUND OF THE INVENTION

1Field of the Invention

The present invention generally relates to solar cells. More particularly, the present invention pertains to methods, structures, and apparatuses for using solar cells with portable devices.

2. Description of the Related Art

It is often said that we in the 21^{st} century live in the mobile revolution. Many devices and apparatuses have become miniaturized in recent years, and many devices are truly portable in terms of their sizes and weights. Some devices such as calculators have been available in portable forms for many decades. Many additional devices, which have been traditionally for use on “desktop” or at home or in the office, have become portable in the last couple of decades in one form or another. This is partly due to recent advances in semiconductor technologies and partly due to consumer demands. For example, mobile phones have been widely deployed in recent years, and the number of cellular phones in use in the United States is predicted to exceed that of wired phones in the next few years. Personal computers have become portable, and laptop sales in the U.S market have been increasing considerably in recent years while desktop computer sales have been stagnating. Smaller data processing devices such as “palmtops” or personal digital assistants, or PDAs, have also been widely available in recent years.

A media player is another such example. Portable devices that can play music and/or display images (including still images and motion pictures) have been available for many years. Recently, digital music players with extremely small form factors, such as iPod® and iPod Nano® of Apple Computer, Inc. based in Cupertino, Calif., have become very popular. These digital music players typically use non-volatile storage devices such as flash memories or hard disks to store digital media content. In some music players, the content is delivered, e.g., through satellite radio. Portable DVD players are also widely available today. Many of the consumer entertainment systems such as television sets or game consoles have recently become available in portable forms as well.

Virtually all portable devices rely on electrical power in one form or another. Some of them rely on various types of batteries which store energy in chemical forms. Some batteries are disposable and they produce only a certain fixed amount of electrical power from the stored energy. Some batteries, such as nickel-cadmium NiMH (Nickel Metal Hydride) or lithium-ion batteries, may be recharged. But, they also generate only a finite amount of electrical energy between recharges. For devices such as portable music players, when they are in continual use, they can be used for about 10 or 20 hours, or often much less, before their batteries need to be replaced or recharged.

Some prior art devices use solar cells to generate electrical power. Solar cells convert light into electricity, and they are typically made of semiconductor materials. Solar cells have been around for many years, but its commercial use has been very limited. This is partly due to economic reasons. The cost of generating a unit amount of energy using currently available solar cell technologies is still more expensive than using other alternative technologies such as those based on fossil fuels. For some applications, however, solar power can be a viable option. Some devices, such as handheld GPS units, are designed to be used outdoors and therefore they can be more suitable to be powered by solar energy. One of the additional benefits of using renewable energies such as solar power is that they are “clean” and environmentally friendly. Products based on solar power can appeal to many environmentally conscious consumers.

Using solar cells on portable devices with small form factors, however, pose certain technical and/or design problems. For example, the small size of the portable device means a small surface area which can be used for placing solar cells. Maximum solar energy that can be produced from a solar panel is roughly proportional to its surface area. Some portable devices might also require certain ruggedness in design due to the manner in which the devices are typically used. These problems are not major concerns in other solar energy applications such as those used to generate household electricity.

FIG. 1 shows a handheld calculator 102 with a built-in solar cell 104. The solar cell or solar panel 104 is embedded on the front of the device. The calculator includes a display 106 and an area for user input, which comprises multiple keys 108. It should be noted that the upper area of the device used for the solar panel could have been used for other purposes, for example, for a bigger display or input area. Alternatively, the overall size of the device could have been reduced were it not for the solar panel.

### BRIEF SUMMARY OF THE DESCRIPTION

The present invention relates to various methods, structures, systems, articles of manufacture, and apparatuses for using solar cells with portable devices. In embodiments of the present invention, solar cells are integrated into a portable device, for example, on the back panel of the device. In some embodiments, multiple cells or tiles are used on the surface of the device, arranged in regular or non-regular patterns. This arrangement allows some of the solar cells to continue to function while others are blocked from sunlight, for example, due to a user's gripping of the device. This is achieved by connecting solar cells in parallel. According to at least one embodiment, some of the solar cells are coupled in series thereby increasing the voltage output. In some cases, these solar cells, connected either in series or in parallel, are arranged such that the cells are likely to produce electricity with a constant voltage as long as a certain fraction of the solar cells are active.

According to embodiments of the present invention, solar cells are stacked with other layers that provide various different functions. For example, in a typical design, the solar cell layer is coupled mechanically and electrically to a flexible printed circuit board (PCB). The power produced from the solar cell is transferred to the PCB layer. In some embodiments, the solar cell layer is stacked with various layers made of transparent or semi-transparent materials, which serve, among other things, as protective layers. These layers are glued with shock absorbent materials. Some of these layers may be used for display or input purposes, and some layers may be coated with various materials or they may be etched for design purposes. This stack of layers may be attached to the device through one or more shock absorbers.

Embodiments of the present invention can be practiced in connection with portable devices with small form factors such as devices having a total exterior surface area of less than about 30,000 mm², or, in certain embodiments less than about 10,000 mm², or even smaller. Designs of some embodiments of the present invention take into account the space constraint in portable devices. Solar cells are arranged to optimize the efficiency in certain embodiments. Areas where solar cells are embedded are reused for display or input purposes in certain embodiments.

One of the benefits of using solar power is that solar energy is clean and it is “environmentally friendly.” Products based on renewable energies such as solar power can appeal to many environmentally conscious consumers. In at least one embodiment, the cumulative energy produced from the solar cells in the device is converted to a value that can be easily appreciated by consumers, and the converted value is displayed on the device.

According to an embodiment of the present invention, multiple solar cells are embedded on the surface of a portable device and they are electrically connected to each other in various ways. In certain embodiments, some of the solar cells are connected in series to increase the voltage output. These solar cells are arranged such that some of the cells continue to function while others may be blocked from sunlight. At least one embodiment of the present invention provides a method for arranging and connecting multiple solar cells on a portable device such that a combined voltage output of the solar cells, when all solar cells are activated, is substantially close to a preset voltage value. In certain embodiments these solar cells are arranged on the portable device so that the preset voltage is likely to be maintained even if a certain fraction of the solar cells are obstructed.

In some embodiments, a group of solar cells are connected in series and generate a necessary voltage output. Multiple groups of solar cells are then connected in parallel to provide sufficient power to the device. In certain embodiments, these groups of solar cells are arranged on the device so that even when one or more groups of solar cells are partially obstructed, the remaining groups of solar cells are capable of generating sufficient power to operate the device. In some embodiments, these groups of solar cells are arranged in alternating patterns, such as a checkerboard pattern. In some other embodiments, solar cells are embedded in more than one side of the device.

According to one aspect of the present invention, a layer of solar cells is stacked with other layers and connected to the device through a shock absorbing material. The solar cell layer is coupled mechanically and electrically to a flexible printed circuit board (PCB). The power produced in the solar cells is transferred to the PCB layer. In certain embodiments, the solar cell layer is stacked with layers made of transparent or semi-transparent materials, which serve, among other things, as protective layers. These layers are glued with shock absorbent materials. In certain embodiments, these layers are used for display and/or input purposes. Some layers may be coated with various materials. For example, the outer glass layer may be coated for anti-reflection purposes in some embodiments. Some layers, including the solar cell layer itself, may be etched for design purposes, for example, with product or company logos.

In at least one embodiment of the present invention, the solar cell layer is used for display purposes. For example, certain information regarding solar cells' functions or performances may be displayed on top of the solar cells. In some other embodiments, this information is displayed on other layers such as semi-transparent LCD displays stacked on top of the solar cells. In some cases, this information is displayed on the main display of the device.

According to an embodiment of the present invention, a method and an apparatus is provided for displaying instantaneous power output from a solar cell on a portable device. The instantaneous power output from the solar cell is first measured and converted to a relative value, for example, as a percentage of the maximum power output. The converted value is then displayed close to the solar cell. In certain embodiments, this instantaneous power output is shown on the main display of the device. In certain other embodiments, the instantaneous power output can be measured directly from a solar cell or from a circuit connected to the solar cell. In some cases, electrochromic or photochromic materials are used which indicate the intensity of the incoming sunlight or the instantaneous power generated from the solar cell at any given moment.

In some embodiments, a cumulative power output from a solar cell is displayed in a user-friendly way. For example, the cumulative power output, or energy, may be converted to an “environmentally friendly value” such as the number of AA batteries equivalent to the measured energy. This environmentally friendly value may be displayed in response to the user's request, or it may always be displayed in one part of the device. In certain embodiments, the back side of a device where solar cells are embedded is used for this purpose. 100181 In certain embodiments, a portable media player includes an enclosure having a total exterior surface area of less than about 30,000 mm², a media processing system disposed within the enclosure, and an input device disposed on the exterior surface of the enclosure. The input device (e.g., a click wheel device) is coupled to the media processing system to select media which is stored on a storage device that is coupled to the media processing system and that is disposed within the enclosure. The portable media player also includes a battery, which is disposed within the enclosure and is coupled to the media processing system and to the storage device and to the input device, and a solar energy device which is coupled to at least one of the battery, the media processing system, the storage device, and the input device. The solar energy device is an integral part of the enclosure and is disposed on at least one exterior surface of the enclosure. In at least some embodiments, the solar energy device is coupled to the enclosure through a shock absorbing material and the total exterior surface area is less than about 10,000 mm² and the solar energy device is coupled to the battery to recharge the battery and the media includes music. The solar energy device may be a plurality of cells formed from rigid semiconductor material and they may be electrically interconnected to provide power even if a subset of the plurality of cells are prevented from capturing light. In certain other embodiments, the total exterior surface area is less than about 6,000 mm² and the solar energy device is coupled only to the battery to recharge the battery.

Therefore, as summarized herein, the present invention provides, among other things, improved methods, systems, and apparatuses for using solar cells with portable devices. These and other embodiments, features, aspects, and advantages of the present invention will be apparent from the accompanying drawings and from the detailed description and appended claims which follow.

### BRIEF DESCRIPTION OF THE DRAWINGS

The present invention is illustrated by way of example and not limitation in the figures of the accompanying drawings, in which like references indicate similar elements and in which:

FIG. 1 shows a prior art, a handheld calculator with a built-in solar cell on the front.

FIGS. 2A-2C illustrate exemplary embodiments of the present invention. In FIG. 2A, a solar cell panel is embedded in the back of a device, whereas in FIG. 2B, a solar cell is placed on the front where the main display and various controls are located. FIG. 2C shows a solar panel embedded on the back side of a cover of a portable computer.

FIG. 3 shows a block diagram illustrating various functional modules according to an embodiment of the present invention.

FIG. 4 is a flow chart illustrating an exemplary process for power management according to an embodiment of the present invention.

FIG. 5 is a block diagram showing various components of an exemplary data processing system, with which embodiments of the present invention can be practiced.

FIG. 6A illustrates a situation in which some of the solar cells are obstructed by a user's hand. In the illustration of FIG. 6B, some of the solar cells are under a shadow.

FIG. 7A illustrates a solar panel comprising multiple solar cells in an embodiment of the present invention. FIG. 7B shows a schematic circuit diagram corresponding to the solar panel of FIG. 7A.

FIG. 8A shows another exemplary solar panel comprising multiple solar cells according to a certain embodiment of the present invention. FIG. 8B is an equivalent circuit diagram corresponding to the solar panel of FIG. 8A.

FIG. 9A is yet another exemplary solar panel comprising multiple solar cells in accordance with some embodiments of the present invention. FIG. 9B schematically shows an equivalent circuit diagram corresponding to the solar panel shown in FIG. 9A.

FIG. 10 shows another schematic circuit diagram in an embodiment of the present invention. Note that the overall circuit generates 1.5 V if each solar cell's output voltage is 0.5 V.

FIG. 11 illustrates an exemplary structure of a solar panel according to an embodiment of the present invention. The solar panel module shown in the figure comprises solar cells as well as a flex PCB and a glass layer.

FIG. 12 shows a structure of another exemplary solar panel in accordance with an embodiment of the present invention. This exemplary solar panel further comprises, among other things, an LCD layer for display.

FIG. 13 shows an exemplary embodiment of the present invention, in which a semi-transparent LCD screen is overlaid on top of the solar cell unit, as shown in FIG. 12.

FIG. 14 represents an exemplary process for constructing a solar panel unit according to an embodiment of the present invention. Note that the various operations shown in the chart need not be performed in a particular order.

FIGS. 15A and 15B illustrate the dependence of the “instantaneous” power generated from solar cells on the orientation of the device, at any given moment.

FIGS. 16A and 16B show various embodiments of the present invention which have instantaneous power indicators. In FIG. 16A, a special area on the device is dedicated for this purpose, whereas, in FIG. 16B, the power level meter is displayed on top of the solar panel.

FIG. 17 is a schematic diagram of a solar panel module in an embodiment of the present invention. The solar panel in the diagram includes an LCD screen which can be used to display the level of solar power generation at any given moment.

FIG. 18A illustrates an exemplary instantaneous power indicator using a photochromic material. FIG. 18B illustrates another exemplary instantaneous power indicator according to an embodiment of the present invention, in which an electrochromic material is used.

FIG. 19 is a flow chart illustrating an exemplary process for implementing instantaneous power meters in at least one embodiment of the present invention.

FIGS. 20A and 20B show user interface examples according to an embodiment of the present invention, in which “environmentally friendly” messages are displayed to the user.

FIGS. 21A-21B is a flow chart illustrating an exemplary process for displaying messages such as those shown in FIGS. 20 according to an embodiment of the present invention.

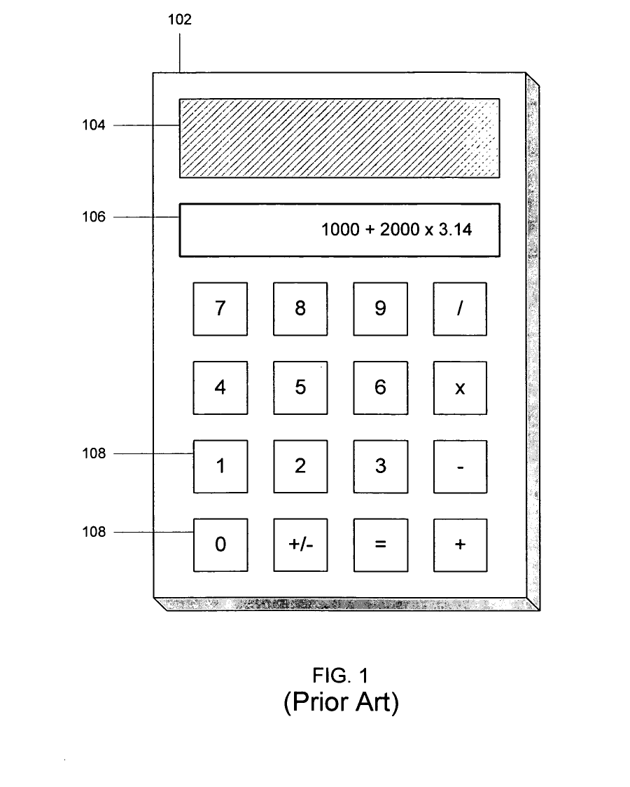

### DETAILED DESCRIPTION

The present invention will now be described more fully hereinafter with reference to the accompanying drawings, in which various exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Likewise, for purposes of explanation, numerous specific details are set forth in the following description in order to provide a thorough understanding of the present invention. It will be evident, however, to one skilled in the art that the present invention may be practiced without these specific details. In other instances, well-known structures and devices are shown in block diagram form in order to avoid unnecessarily obscuring the present invention.

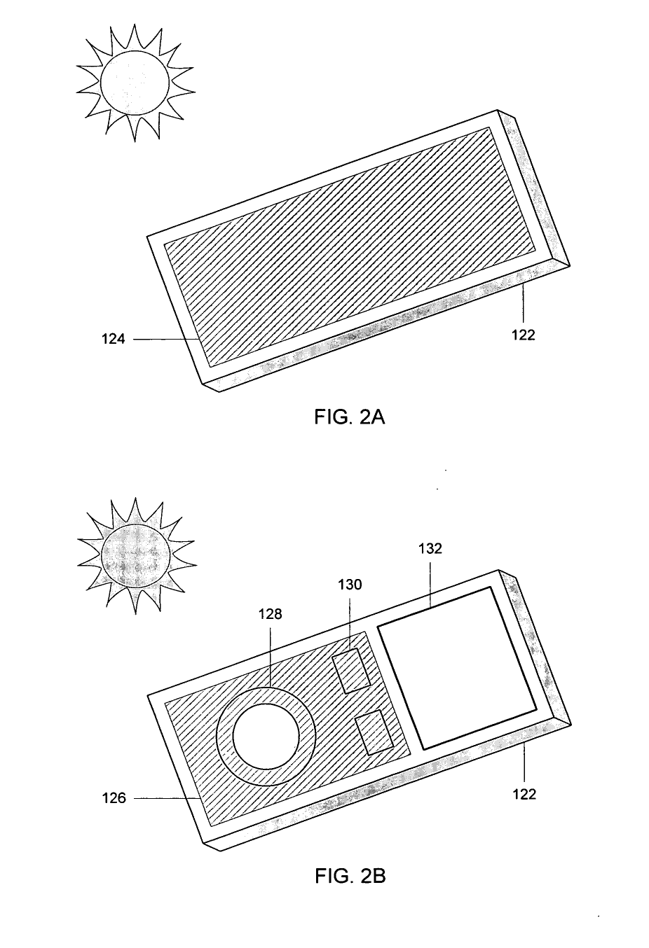

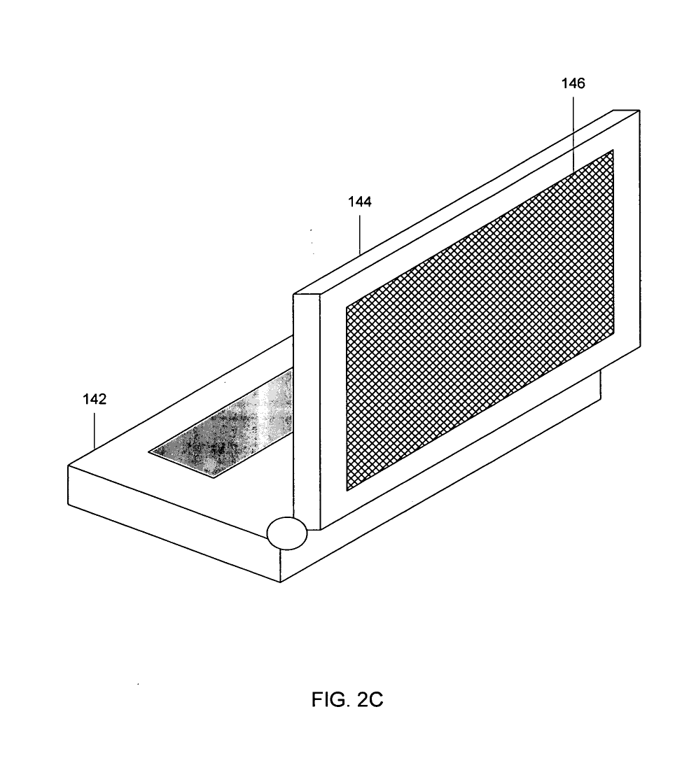

With reference now to figures, FIGS. 2A and 2B illustrate exemplary embodiments of the present invention. The figures show a small data processing device 122 with a rectangular brick shape. This exemplary device has a relatively small third dimension as is common with many portable devices and it has a well defined front side and back side. In certain embodiments, the total exterior surface area of the portable device, which may be a portable media player, may be less than about 30,000 mm² (e.g., the dimension of the structure may be 140 mm by 75 mm by 20 mm) or may be less than 10,000 mm². FIG. 2A shows the back side of the device whereas FIG. 2B depicts the front side where a main display 132 and a user input panel is located. The user input panel includes an input wheel 128 and various input keys or buttons 130. In some devices, some additional input mechanisms may be found on sides other than the front of the device. Additional displays may be included on other sides also. In the exemplary device shown in FIG. 2A, a solar cell panel 124 is embedded on the back side of the device, where no other functional units are found. On the other hand, in FIG. 2B, a solar cell 126 is placed on the front of the device in the area where various input controls are located. In this example, at least a portion of the input panel is transparent or semi-transparent so that the solar cell can be functional if it is given strong enough light, such as direct sunlight, as illustrated in the figure. In some embodiments, the input panel can be implemented as a touch pad made of transparent or semi-transparent material.

It should be noted that some devices may have a polyhedral shape other than a simple hexahedron, with the number of sides different from six. Some devices may have more complex shapes with flip covers, foldable keypads, etc. Embodiments of the present invention can also be practiced with these types of devices with “irregular” shapes. On such a device, solar cells may need to be embedded on the outside surface of the device, preferably, where the solar cells can be exposed to ambient light. FIG. 2C illustrates a solar panel embedded on the back side of a cover of a portable computer. The portable computer, or the laptop, shown in the figure comprises a base unit 142 and a display unit 144. The base unit 142 typically includes input devices such as keyboards and touch pads on its top surface. The display unit 144 includes a display screen (not shown in the figure) on its one side, which is usually facing the base unit when opened. On the other side of the base unit is embedded a solar panel 146. It should be noted that, in the exemplary laptop shown in the figure, the solar panel 146 is exposed to the outside even when the display unit is closed (e.g., when the device is not being used).

A solar cell is a device that converts light into electricity. Typically a solar cell comprises a light absorbing material, which is usually semiconductor-based. Many of the modern solar cell designs use crystalline silicon wafers or amorphous silicon films which are rigid; alternative materials, such as those produced by Nanosolar of Palo Alto, Calif. are not rigid. This phenomenon of converting light into electricity is called photovoltaic effect. When light hits the solar cell and is absorbed by the photovoltaic material, the absorbed energy is converted to DC (direct current) electricity by separating negative and positive charges (e.g. electrons and holes) in the light-sensitive material. The generated DC electricity is then transmitted to the device, which consumes the electricity, through electrical contacts or transmission lines.

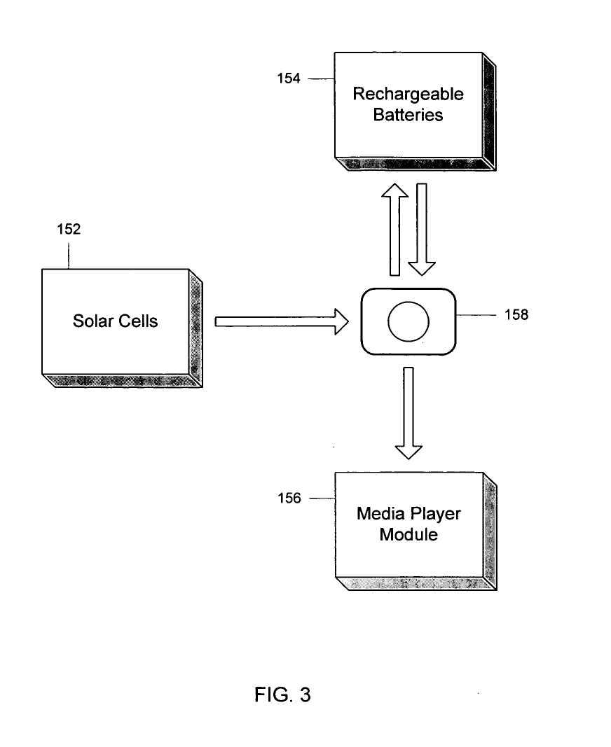

The present invention generally relates to various methods and systems for using solar cells with portable devices such as PDAs or digital media players. In particular, in embodiments of the present invention, solar cells are integrated into a portable device. The solar energy device (e.g., the plurality of solar cells) are an integral part of the enclosure of the portable device; for example, the solar energy device may be coupled, through a shock absorbing material, to the exterior enclosure such that the enclosure, with the solar energy device, may be separated from the internal electrical components (e.g., media processing system, storage device, and battery). According to at least one embodiment of the present invention, the devices have rechargeable batteries. The solar cells embedded into the device then provide the electrical power to charge the batteries. The power generated from the solar cell can also directly power the operations of the device. This is illustrated in FIG. 3. The figure depicts a block diagram illustrating various functional modules according to an embodiment of the present invention. It includes one or more solar cells 152, one or more rechargeable batteries 154 and a main operational module 156 of the device. In this example, the device's main function is assumed to be that of playing digital media such as music or video. The switch or gateway 158 is a schematic representation of a (virtual) unit responsible for the “traffic control” of the electricity flow in the device. This unit may or may not be a concrete unit including circuit elements. In some embodiments, this circuitry 158 may contain boost converter to change the voltage coming from the solar cells 152 to a value suitable for the batteries 154 or the main unit 156. The arrows in the figure represent the possible flow of electricity. The electric power generated from the solar cells 152 can be used either to charge the rechargeable batteries 154 or to directly power the main module 156, or both. The main module can also be powered directly by the batteries 154 as indicated by the arrows. The rechargeable batteries can be charged by the solar cells 152 as well as external power sources (not shown in the figure).

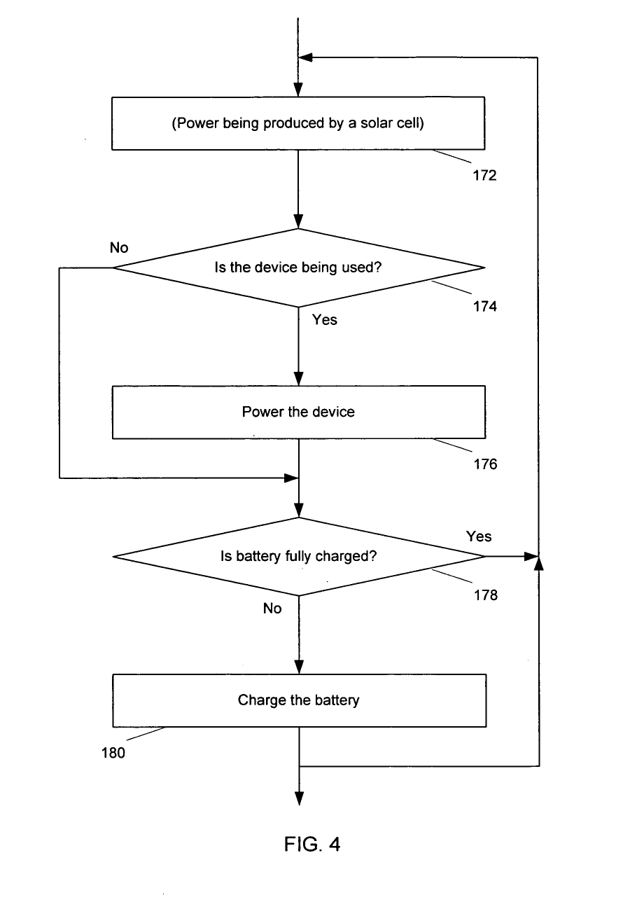

FIG. 4 illustrates the flow of electricity in a device powered by solar cells according to an embodiment of the present invention. As with the “traffic control” unit 158 of FIG. 3, this flow chart may not represent any concrete process that needs to be implemented with extra circuitry. This chart may be viewed as an illustration of the internal process of the power flow in an exemplary device such as those depicted in FIG. 3. In some embodiments, however, this process may be implemented with explicit functional units, possibly with configurable options and/or with associated user interfaces. The exemplary process of FIG. 4 starts when the solar cells are exposed to bright light and the solar cells generate electricity as indicated in a block 172. When the device is being used, the instantaneous electric power generated from the solar cells may be used to directly power the device, at blocks 174 and 176. If not, following the No branch from block 174, the generated energy may be used to charge the batteries, at 180. Any leftover electricity after powering the device, 176, may also be used to charge the batteries. If the batteries are currently fully charged, the electric power generated from the solar cell will not be used, and the process returns to the beginning following the Yes branch at block 178. Otherwise, the generated solar energy is used to charge the batteries at 180. In cases where this process is implemented with additional functional units, the decision blocks such as 174 and 178 may be overridden by system settings and/or by user-provided options.

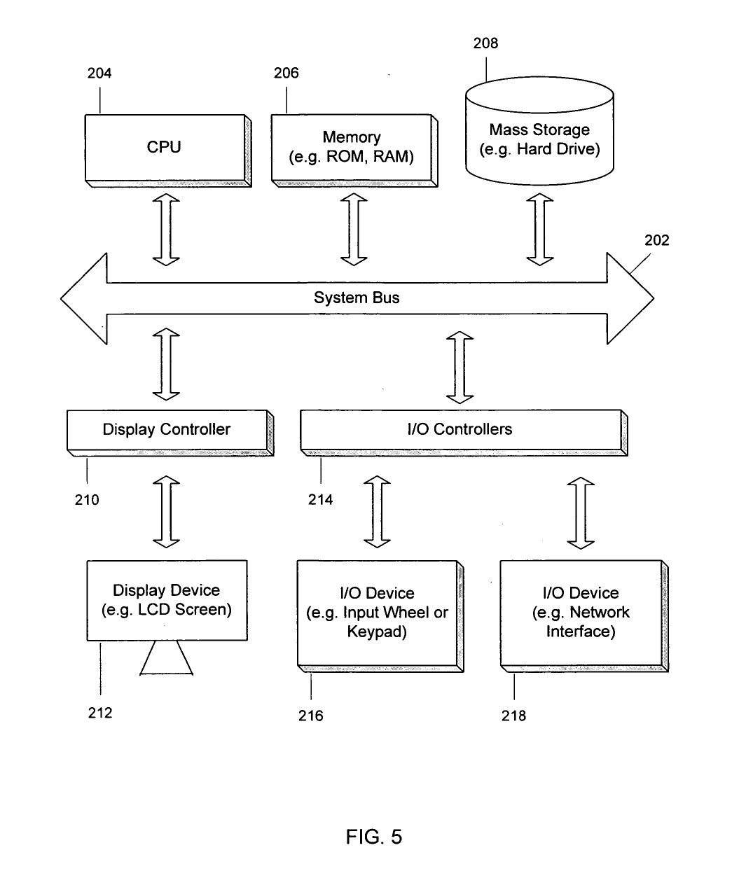

Now turning to FIG. 5, a block diagram is shown illustrating various components of an exemplary portable device, more specifically, a data processing system or a digital media player. This data processing system can be used with various embodiments of the present invention. As will be appreciated by one of skill in the art, however, the present invention may be embodied as a method, data processing system or program product as well as an article of manufacture or an apparatus. Thus the scope of the invention should be determined by the appended claims and their legal equivalents, and not by the examples given. Note that while the block diagram of FIG. 5 illustrates various components of a data processing system, it is not intended to represent any particular architecture or manner of interconnecting the components. It will also be appreciated that personal computers, laptops, and network computers, and other data processing systems such as cellular telephones, personal digital assistants, entertainment game systems, music players, etc. which have fewer components or perhaps more components and which have components arranged in a different architecture or configuration may also be used with the present invention. The computer system of FIG. 5 may, for example, be a portable computer system (e.g., a laptop) from Apple Computer. Inc.

As shown in FIG. 5, the exemplary data processing system includes a bus 202 which is coupled to a microprocessor(s) 204 and a memory 206 such as a ROM (read only memory) or a volatile RAM and a non-volatile storage device(s) 208. The system bus 202 interconnects these various components together and also interconnects these components 204, 206, and 208 to a display controller(s) 210 and display devices 212 such as LCD screens and to peripheral devices such as input/output (I/O) devices 216 and 218 which may be mice, keypads, input wheels, modems, network interfaces, printers and other devices which are well known in the art. Typically, the I/O devices 216 and 218 are coupled to the system through I/O controllers 214. The volatile RAM (random access memory) 206 is typically implemented as dynamic RAM (DRAM) which requires power continually in order to refresh or maintain the data in the memory. The mass storage 208 is typically a magnetic hard drive or a magnetic optical drive or an optical drive or a DVD ROM or other types of memory systems which maintain data (e.g. large amounts of data) even after power is removed from the system. Typically, the mass storage 208 will also be a random access memory although this is not required. While FIG. 5 shows that the mass storage 208 is a local device coupled directly to the rest of the components in the data processing system, it will be appreciated that the present invention may utilize a non-volatile memory which is remote from the system, such as a network storage device which is coupled to the data processing system through a network interface 218 such as a modem or Ethernet interface. The bus 202 may include one or more buses connected to each other through various bridges, controllers and/or adapters as is well known in the art. In one embodiment, the I/O controller 214 includes a USB (universal serial bus) adapter for controlling USB peripherals and an IEEE 1394 (i.e., “firewire”) controller for IEEE 1394 compliant peripherals. The display controllers 210 may include additional processors such as GPUs (graphical processing units) and they may control one or more display devices 212.

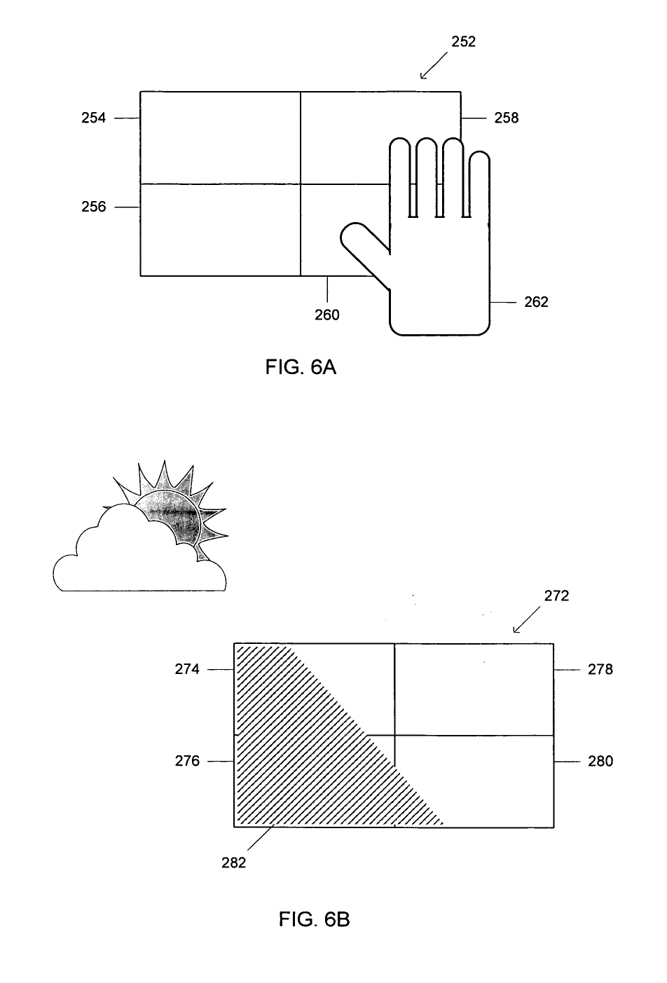

Using solar cells on portable devices raises some technical and/or usability issues. For example, portions of solar cells on handheld devices might be obstructed from bright light such as direct sunlight by the user's hands or other objects. Also, due to their very nature, portable devices may not always be oriented in the optimal direction, e.g. facing orthogonally toward the incoming sunlight. They may not always be placed in an optimal location or environment, such as on a roof of a building (which is possible, for example, in the case of solar cells used to generate home or office electricity). This is illustrated in FIGS. 6A and 6B. In this pair of figures, exemplary solar panels 252 and 272, respectively, are depicted, which may be embedded on a surface of a portable device (not shown in the figures). In these particular examples, each solar panel is comprised of four solar cells. That is, the solar panel 252 of FIG. 6A includes four solar cells 254, 256, 258, and 260, and the panel 272 of FIG. 6B includes four cells 274, 276, 278, and 280.

FIG. 6A illustrates a situation in which the solar panel 252 is obstructed by a user's hand 262. For portable devices, which are typically held by users' hands, the solar cells embedded on surfaces of the devices might be easily obstructed during their normal operation. The energy generated from the solar cells will typically be diminished in proportion to the obstructed surface area. In the illustration of FIG. 6B, the solar panel 272 is under a shadow 282, represented by the shaded area in the figure. Again, the generated solar energy will be diminished roughly proportional to the area hidden under the shadow. It should be noted that, in the examples shown here where the solar panels include multiple solar cells, some of the solar cells may be fully functional even when portions of the solar panels are obstructed. For example, the solar cells 254, 256, and 278 are unobstructed as illustrated in the figures.

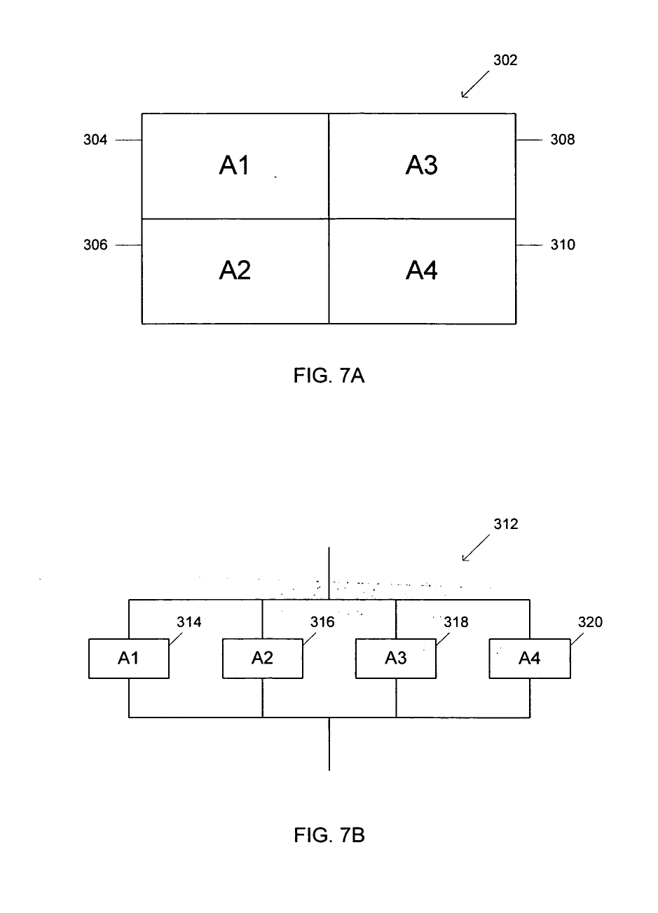

In some embodiments of the present invention, more than one solar cells or tiles are placed on the surface of a portable device for various purposes. They are sometimes arranged in a regular pattern such as shown in FIGS. 6. In some cases, they may be arranged in a non-regular pattern. In some cases, the solar cells may be of different shapes. Using multiple cells allows some of the solar cells to continue to function while others are blocked from sunlight, for example, due to a user's gripping of the device. According to at least one embodiment, some of the solar cells are coupled in series thereby increasing the output voltage. In certain embodiments, these solar cells are connected in series and/or in parallel, and they are arranged such that the cells produce a constant preset voltage as long as a certain fraction of the cells are active. Using multiple solar cells, which are connected in parallel, provides redundancy. For example, FIG. 7A illustrates a solar panel 302 comprising multiple solar cells according to an embodiment of the present invention. These solar cells 304, 306, 308, and 310 are electrically connected in parallel in this example as schematically shown in FIG. 7B. In this “circuit diagram” 312, the blocks 314, 316, 318, and 320 represent the solar cells 304, 306, 308, and 310 of FIG. 7A, respectively. In this particular example, all solar cells have the same output voltage. When any one or more cells are completely obstructed, the overall circuit 312 will still have the same voltage output, namely, that of a single solar cell. This will hold true unless all of the solar cells are entirely obstructed.

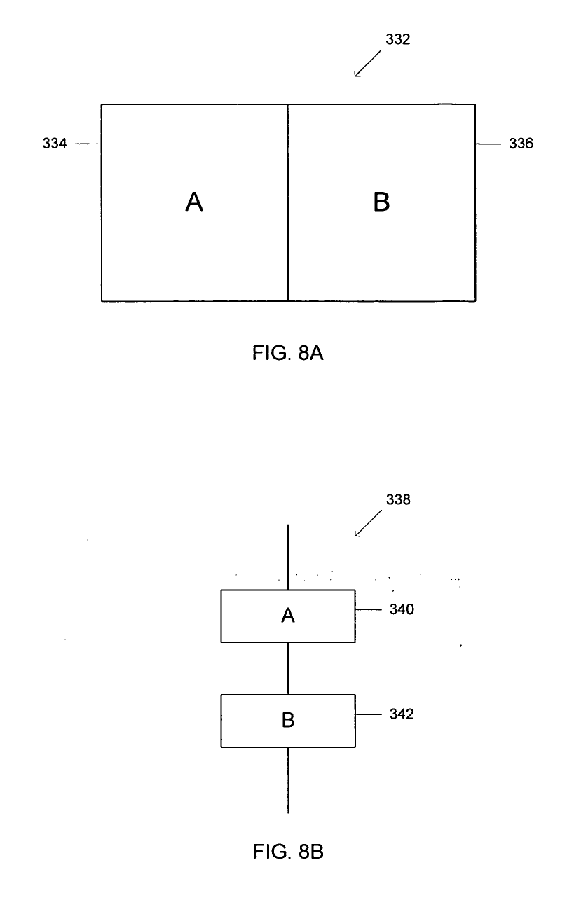

FIGS. 8A and 8B, on the other hand, show another exemplary solar panel according to an embodiment of the present invention in which solar cells are connected in series. FIG. 8A shows a solar panel 332 comprising two solar cells 334 and 336. FIG. 8B illustrates an equivalent circuit diagram 338 corresponding to the solar panel of FIG. 8A. The blocks in this figure represent solar cells with certain polarities (not indicated in the figure). Blocks 340 and 342 correspond to solar cells 334 and 336, respectively. As shown in this pair of figures, the solar cells 334 and 336 are electrically connected in series (with appropriate polarities). The overall voltage output of circuit 338 is the sum of those of 340 and 342. This arrangement can be used, for example, when the output voltage of available solar cells is smaller than the required voltage, e.g., necessary to power a main operational module of the device or to charge the rechargeable batteries (without voltage conversion). For instance, a device that requires 1.0 V input power can be powered by two solar cells connected in series, each generating 0.5 V of output. One of the downsides of this particular arrangement is its vulnerability to surface obstruction. For example, if solar cell 334 of FIG. 8A, or 340 of FIG. 8B, is completely obstructed for some reason, the whole circuit 338 may not generate any power even though the other cell 336, or 342, may still be functional.

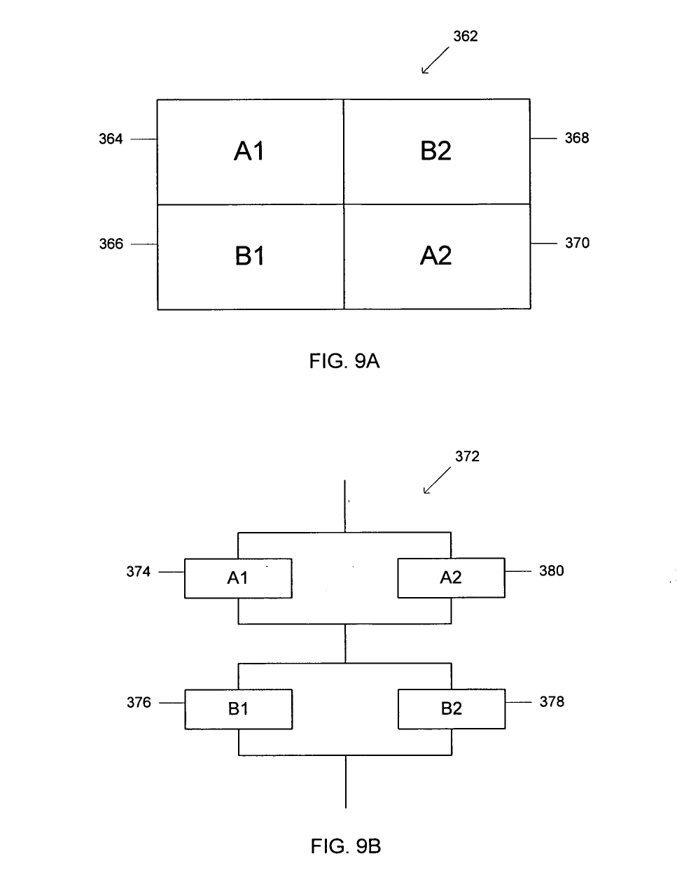

FIG. 9A shows another exemplary solar panel comprising multiple solar cells in accordance with some embodiments of the present invention. The solar panel 362 illustrated in the figure comprises four solar cells 364, 366, 368, and 370. As indicated in the figure, two cells 364 and 370 are of the same “types” and two cells 366 and 368 are of the same types. In particular, cells 364 and 370 of this example have the same voltage output when fully activated. Likewise, cells 366 and 368 have the same output voltage. These cells are electrically connected as schematically illustrated in a circuit diagram 372 of FIG. 9B. In this example, two blocks or solar cells 374 and 380, representing solar cells 364 and 370 of the same type shown in FIG. 9A, are connected in parallel, and likewise cells 376 and 378, corresponding to 366 and 368, are connected in parallel. These two pairs of cells are then connected in series as shown in the figure. The output voltage of the overall circuit 372 is the sum of the voltage of solar cell 364 (or 370) and that of solar cell 366 (or 368). As illustrated in FIG. 9A, these four solar cells are arranged in an alternating pattern, or in particular in a “checkerboard” pattern in this example. That is, the two solar cells 364 and 370 of the same type, which are connected in parallel, are placed diagonally opposite to each other. Likewise, cells 366 and 368 connected in parallel are placed at the opposite corners of solar panel 362. This arrangement of solar cells provides some level of robustness against partial obstruction of the solar panel while providing the benefit of increasing the output voltage to a desired level as illustrated in connection with FIGS. 8. In this particular arrangement shown in FIG. 9A, if one half of the panel is completely obstructed, the panel is still functional and it will generate power with a desired voltage output under proper conditions, such as when exposed to strong light. For example, when solar cells 364 and 366 are entirely obstructed, e.g., by a user's hand, the circuit 372 is functional by generating power from cells 378 and 380 only. Likewise, obstructing cells 364 and 368 leaves the circuit functional with two other cells (connected in series) in active states, thereby generating power with a desired voltage output.

In some embodiments, the cells may be connected in series first, for example, to increase the output voltage, and then the combined solar cells may be connected in parallel. Using the example of FIG. 9A, one possible connection would be connecting solar cells 364 and 366 in series and likewise connecting solar cells 368 and 370 in series. Each pair of cells generates the same voltage output as circuit 372 shown in FIG. 9B. These pairs are then connected in parallel similar to the circuit 312 of FIG. 7B. This multiple branching provides redundancy against possible partial obstruction of the panel as explained earlier.

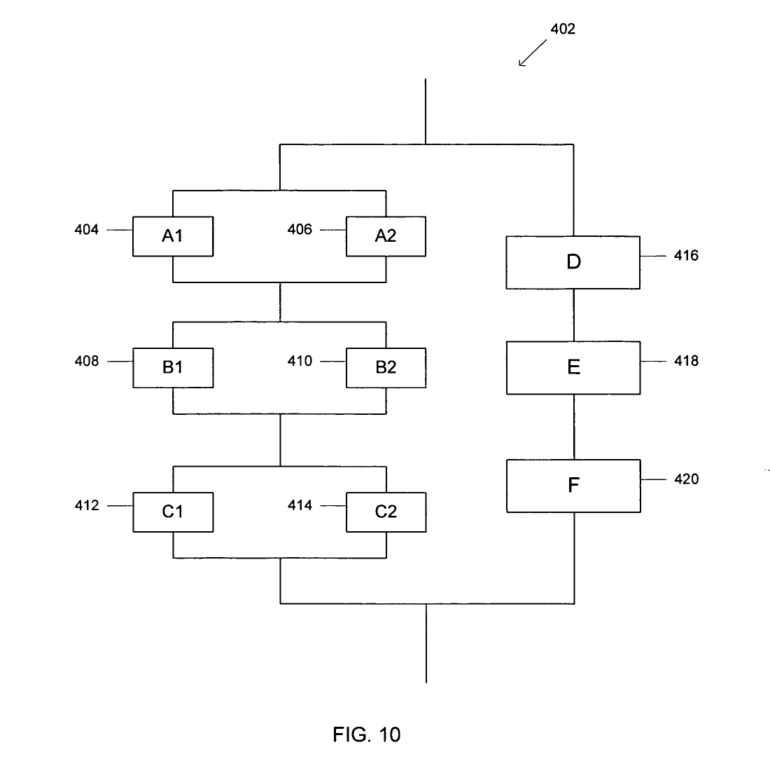

It should be noted that even though we have illustrated these features of some of the embodiments of the present invention using two or four solar cells, this idea can be generalized to solar panels containing different number of cells. The physical arrangement can be generalized to checkerboard layouts or more general layouts, e.g., with different “types” of solar cells placed in an alternating fashion in some way. The manner of electrical connection can also be extended to more general connections, not limited to simple series-parallel or parallel-series types of circuits. For example, FIG. 10 shows a schematic circuit diagram in an embodiment of the present invention, where multiple solar cells are connected to generate power with a target voltage output. The exemplary circuit 402 contains nine solar cells which may be arranged in some regular or non-regular pattern on a surface of a portable device (not shown). Cells 404 and 406, cells 408 and 410, and cells 412 and 414 are connected in parallel to each other, and these six solar cells are connected in overall series. As indicated by the same letters in the labels, these pairs of cells are of the same “type”. The other three solar cells 416, 418, and 420, which are connected in series among themselves, are then connected in parallel to the first six cells. In this particular connection pattern, the voltage output of the overall circuit 402 is the sum of those of 416, 418, and 420, or the sum of those of 404, 408, and 412. For example, the overall circuit generates output voltage of 1.5 V if each solar cell's output voltage is 0.5 V.

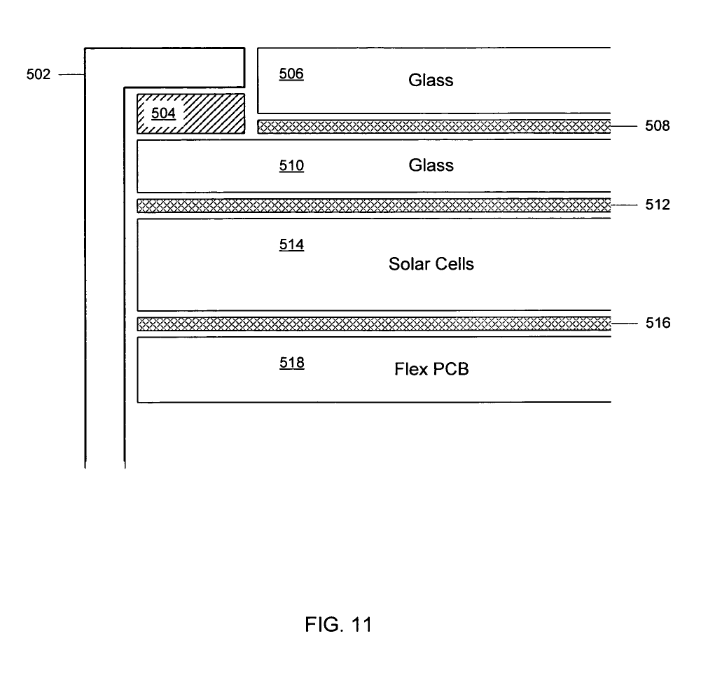

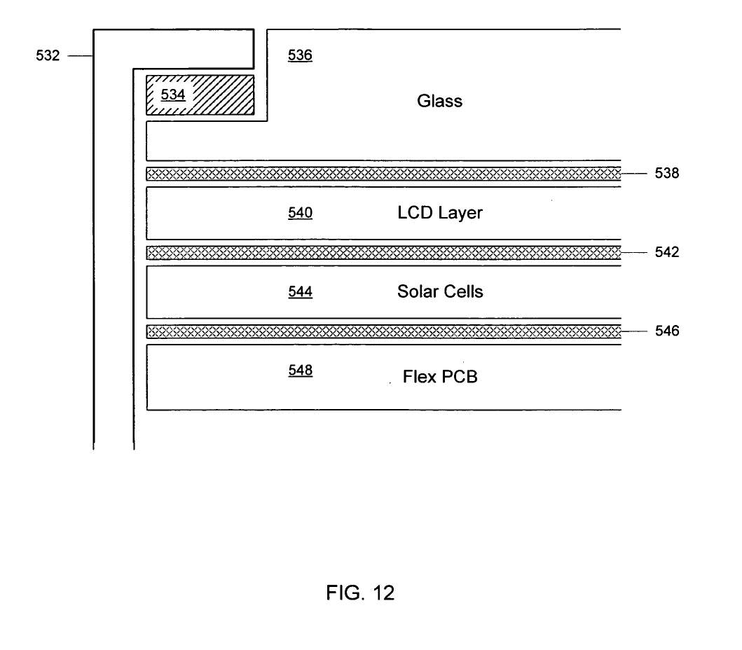

With reference now to FIGS. 11 and 12, some of the exemplary structures of a solar panel according to embodiments of the present invention are illustrated. In certain embodiments of the present invention, solar cells are stacked with other layers that provide various functions. For example, in a typical design, the solar cell layer is coupled mechanically and electrically to a flexible printed circuit board (PCB). The electric power produced from the solar cells is transferred to the PCB layer, which supply power to the rest of the device. In some embodiments, the solar cell layer is stacked with layers made of transparent or semi-transparent materials, which serve, among other things, as protective layers. These layers may be glued with shock absorbent materials. Some of these layers may be used for display or input purposes. Some layers may be coated with various materials or they may be etched for design purposes, for example, with product or company logos. Structures comprising these layers including the solar cell layer may be attached, for instance, to the frame of the device using shock absorbing glues.

FIG. 11 illustrates an exemplary structure of a solar panel according to an embodiment of the present invention. The solar panel structure shown in the figure may be attached to a frame 502 of a portable device. The drawing can be viewed as a portion of a cross section of the device, for example, the exemplary device shown in FIG. 2A. The top and left parts of the figure represent the outside, and the device extends to the left and downward directions. In this example, the solar panel shown on the right-hand side of the figure is attached to frame 502 through glue 504. In at least one embodiment of the present invention, a special type of glue is used which absorbs external shocks or vibrations to protect the solar panel. When a portable device is dropped, for example, some of the impact to the frame 502 may be dissipated in the shock absorbing glue 504. In some embodiments, there is maintained a small but finite gap between the frame 502 and the outermost glass layer 506. In other embodiments, rather than glue 504, the solar panel may be attached to the frame through a gasket (e.g. a shock absorbing gasket) which may include an adhesive layer on the top and bottom surfaces of the gasket.

The exemplary solar panel module shown in FIG. 11 includes four layers 506, 510, 514, and 518, which are tied to each other through glue, 508, 512, and 516. In some embodiments, shock absorbing glue is also used to stick these layers together. It should be noted that glue, 508 and 512, used outside the solar cell layer 614 should preferably be transparent or nearly transparent so as not to block light from reaching the solar cells. The outside layers 506 and 510 are made of transparent or semi-transparent materials, such as glass or plastic, in some embodiments of the present invention. As illustrated in the figure, the outside glass layer 506 is flush with the outside edge of frame 502 in certain embodiments. The solar cell layer 514 is attached to a flexible printed circuit board (PCB) layer 518 through glue 516. The solar power generated from the solar cells 514 will be transferred to electric circuits in the flexible PCB layer 516. The electric power will then be transferred to the main part of the device (not shown in the figure) to power various components, for example, those shown in FIG. 5. According to at least one embodiment, the flex PCB layer is built on top of an additional layer, for example, made of graphite material. This extra layer may serve as a heat sink to dissipate the heat generated from the solar cells 514 and/or from various circuit elements on the PCB board 518.

In some embodiments, the outer surface of the outermost layer 506 is coated or laminated with various materials. For example, anti-scratch coating may be used to protect the surface, especially when the layer is made of materials such as plastic, which are prone to scratching. Other layers may also be coated with various materials. In certain embodiments, one or more transparent layers are coated for anti-reflection purposes. Properly done anti-reflection coating will increase the solar power output by increasing the light input to the solar cells in the wavelength range for which the solar cells are most sensitive. According to some embodiments, at least one surface of the glass layers, 506 and 510, or the solar cell layer 514 is etched with various patterns. For example, outside surfaces of one or more solar cells may be etched with product logos or other symbols or design patterns. Likewise, either side of a glass panel may be etched or painted with semi-transparent dies.

FIG. 12 shows a structure of another exemplary solar panel in accordance with at least one embodiment of the present invention. The figure schematically depicts a cross section of a portable device similar to the one shown in FIG. 11. These solar panels are drawn in the same orientation. In particular, the upward direction in the figure represents the direction outward from the device. The solar panel structure on the right-hand side of the drawing is attached to the frame 532 of the device with glue 534. In some embodiments, shock-absorbing glue is used to protect the solar panel. In other embodiments, rather than glue 534, the solar panel may be attached to the frame through a gasket (e.g. a shock absorbing gasket) which may include an adhesive layer on the top and bottom surfaces of the gasket. The exemplary solar panel structure shown in FIG. 12 includes four distinct layers, 536, 540, 544, and 548, which are attached to each other through glue 538, 542, and 546. The outermost panel 536 serves, among other things, as a protective layer. In certain embodiments, transparent or semi-transparent materials such as glass are used, possibly with various coating or laminations as stated earlier. In this particular example, an extra layer 540 is included between the glass layer 536 and the solar cell layer 544, which is in turn attached mechanically and electrically to a flexible PCB layer 548. The extra layer 540 is used for display purposes. In some embodiments of the present invention, a transparent or semi-transparent liquid crystal display (LCD) is used.

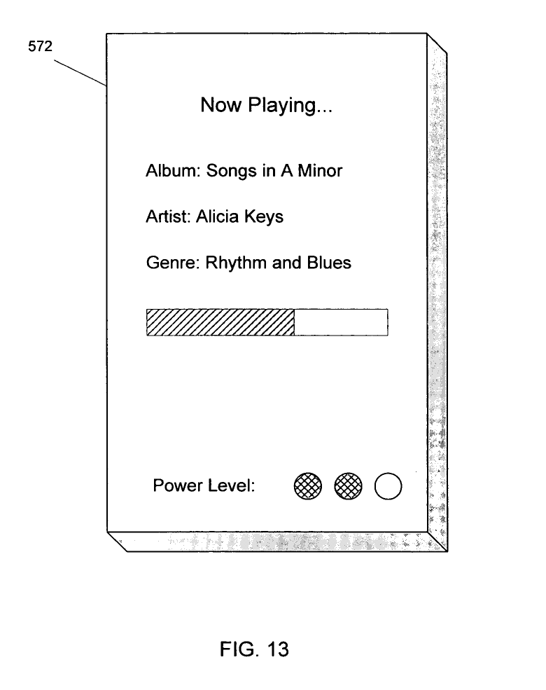

FIG. 13 shows an exemplary embodiment, in which a semi-transparent LCD screen is overlaid on top of the solar cell unit. The figure depicts the “back” side of a portable device 572. Various information is displayed on the backside LCD display as illustrated in the drawing. In some embodiments, the LCD screen is used as a supplemental display to the main display screen (not shown in the figure). For example, the LCD screen of FIG. 13 shows information regarding the digital media currently being played by the device. It also shows the current power level at the bottom of the screen. In certain embodiments of the present invention, information regarding solar cells' functions or performances may be displayed directly on top of the solar cells. In certain other embodiments, this information may be relayed to the main display of the device or to an extra LCD screen laid on top of the solar cells.

According to at least one embodiment of the present invention, a solar panel structure further comprises input layers. For example, a touch sensitive panel, or touchpad, may be stacked on top of the LCD layer 540 of FIG. 12. The touch sensitive panel is typically used on various personal digital assistants or tablet PCs. The touchpad layer can be used as an auxiliary input panel or it can be used as a main input mechanism as in the example of FIG. 2B.

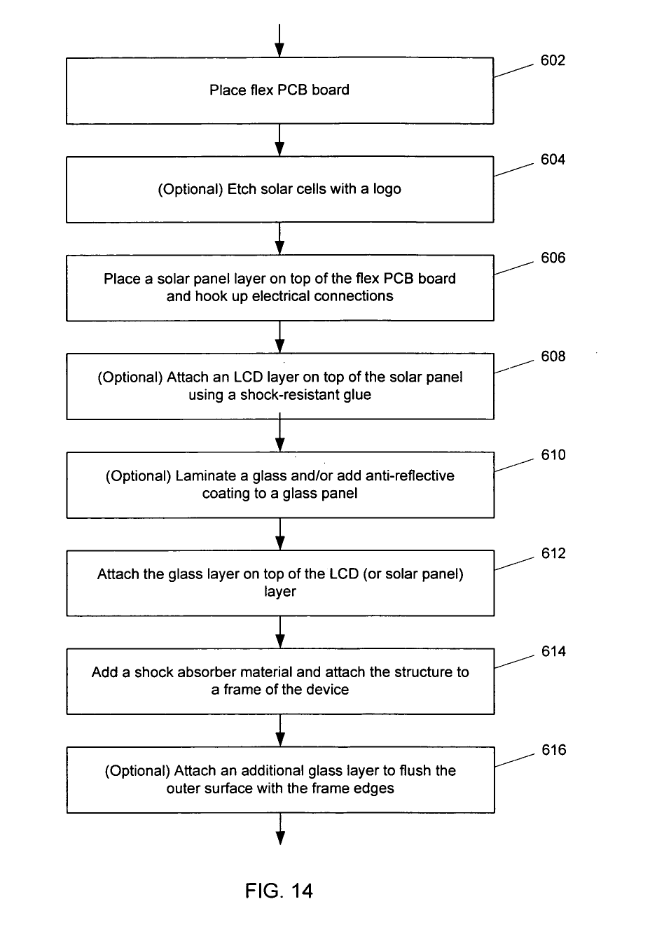

FIG. 14 shows a flow chart for constructing a solar panel unit according to certain embodiments of the present invention. This flow chart is not intended to show the actual manufacturing process. In particular, the exemplary operations shown in the chart may not need to be performed in any particular order. The chart starts from the bottom layer and moves upwards, for example, with reference to the structures shown in FIG. 11 or FIG. 12. As shown in the chart, the solar panel structure is built by first placing a flexible printed circuit board (PCB) layer at 602. As stated earlier, the PCB layer is used to “harness” the solar power generated from the solar cells. In some embodiments, the PCB layer is built on a heat dissipation layer, for example, made of graphite materials. The solar cell layer is then stacked on top of the PCB layer at block 606, and necessary electrical connection is made. For example, the solar cells may be connected in various ways as shown in FIGS. 7 through 10. In some embodiments, the solar cells may be coated with various materials or etched with product logos before they are attached to the PCB layer, as indicated in block 604. An optional display and/or input layer may be placed on top of the solar cell layer in certain embodiments, 608. Then one or more glass or plastic layer is glued on top of the solar cell layer, or onto the LCD or touchpad layer, as indicated in block 612. The transparent glass or plastic layers may also be coated or laminated before they are attached to the solar panel structure, at 610. Or, the outermost layer may be coated, laminated, or etched after the whole structure is built in some embodiments. Then, the solar panel structure is attached, at 614, to the frame of the device using, for example, shock-absorbing glue. In some cases, an additional layer made of transparent or semi-transparent materials may be glued on top of the built solar panel structure to make the outer surface flush with the outer edges of the frame, as illustrated in block 616.

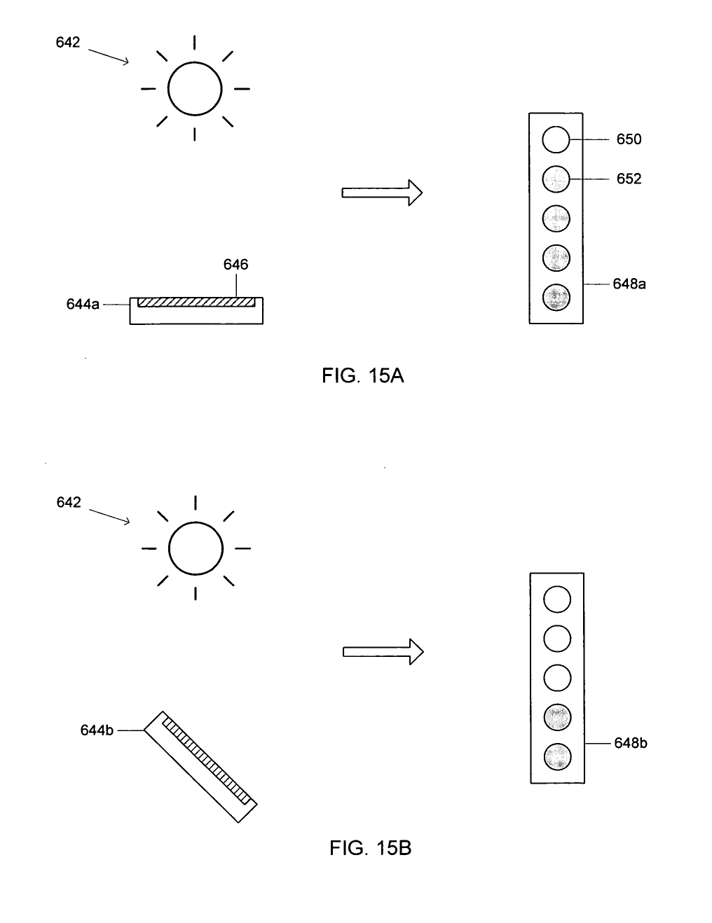

Now turning to FIGS. 15A and 15B, the dependence of the amount of instantaneous power generated from solar cells on the orientation of a portable device is shown. As illustrated earlier in connection with FIGS. 6A and 6B, solar cells on a portable device may not always be fully, or optimally, functional at any given moment for various reasons. FIGS. 15A and 15B illustrate another such situation, which is more or less particular to portable devices. These figures show a portable device, labeled 644a in FIG. 15A and 644b in FIG. 15B, in two different orientations. The device includes a solar panel 646 on one side of the device. In FIG. 15A, the device 644a is oriented more or less orthogonal to the incoming sunlight. The amount of the solar energy from the sun, schematically depicted as a circle 642 in the figures, that is used to activate the solar cells depends on the angle between the surface of the solar panel and the direction of the sunlight. This is schematically represented by the number of turned-on “light bulbs” in an instantaneous power indicator 648a. In FIG. 15A, four light bulbs are lighted indicating a high level of solar power generation. On the other hand, in FIG. 15B, the device 644b is oriented in an oblique angle from the sun 642 and the power generated from the solar cells is relatively low, which is indicated by two lighted circles out of five in the instantaneous power indicator 648b.

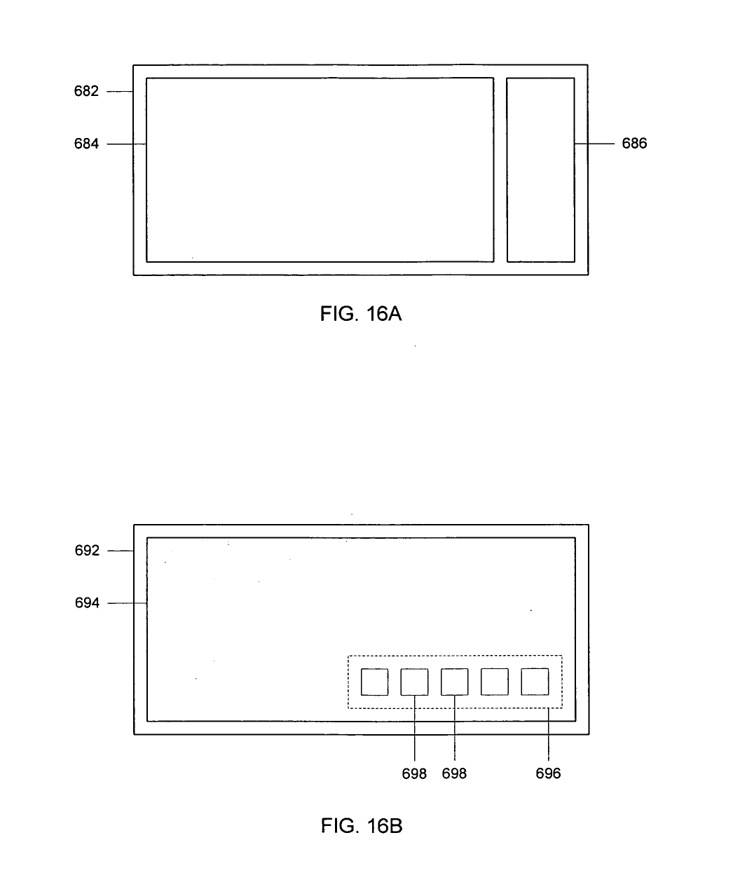

In some embodiments of the present invention, instantaneous power indicators such as those shown in FIGS. 15 are provided in various forms in the user interface. Typical users of portable devices with built-in solar cells may not always be aware of particular conditions in which the devices are placed, e.g., in terms of the solar cells' efficiency, and instantaneous power indicators can be useful features. FIG. 16A illustrates an embodiment of the present invention with an instantaneous power indicator. The exemplary embodiment shows the back panel of a portable device 682 with a built-in solar panel 684. In this embodiment, a special area 686 on the back panel of the device is dedicated for display purposes. This display area can be used to display the instantaneous power level. In the embodiment illustrated in FIG. 16B, on the other hand, the solar panel area is directly used for this purpose. This drawing shows the backside of a portable device 692 with a solar cell panel 694. The instantaneous power indicator 696 is displayed on top of the solar panel. For example, the LCD layer 540 of the exemplary solar panel structure shown in FIG. 12 may be used for this purpose. This particular power level indicator 696 of FIG. 16B comprises five LED, or otherwise graphically simulated, lights to indicate power levels generated from solar cells at any given moment. Bistable LCD panels may also be used for this purpose. In some embodiments, one or more power level indicators are associated with each solar cell or a group of solar cells rather than one global indicator representing the power generated from all solar cells on the device. This can be useful, for example, when solar cells are embedded in more than one side (e.g., front and back) of the device.

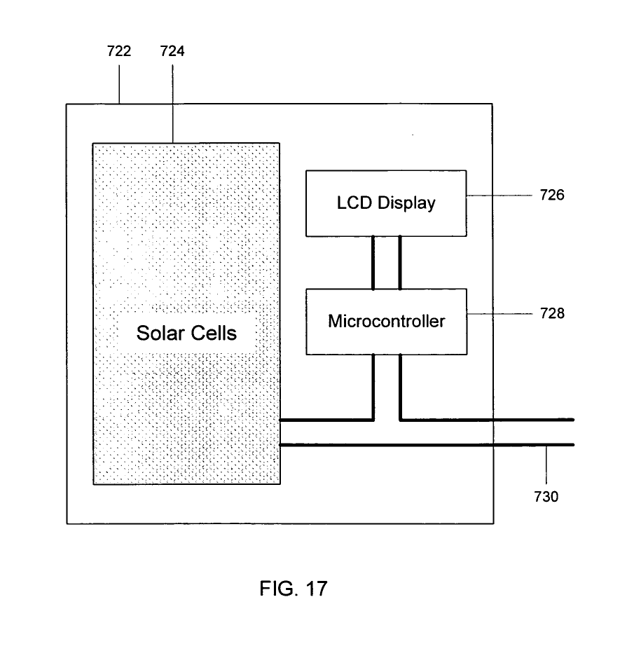

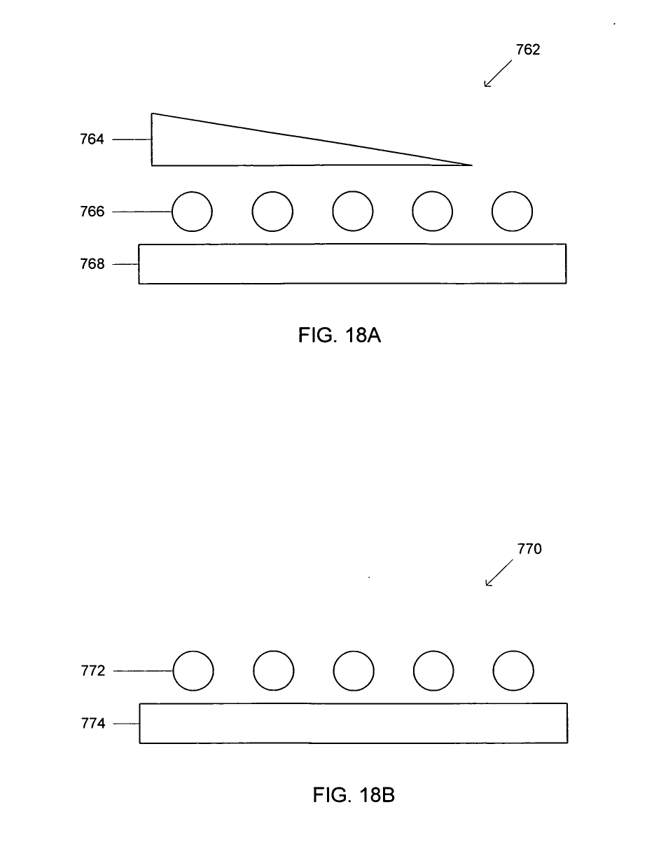

Instantaneous power indicators can be implemented in various ways. In some embodiments, the central processing module of a device is used, together with any extra circuit elements (e.g. the component 158 of FIG. 3), to measure the power generated from solar cells. In certain embodiments, the electrical energy generated from one or more solar cells is measured and processed locally, that is, on or near the solar panel before the electricity is transmitted to the main module. This is illustrated in FIG. 17. In certain other embodiments, “passive” implementations may be used, for example, using photochromic or electrochromic materials. This approach is illustrated later in connection with FIGS. 18.

FIG. 17 is a schematic diagram of a solar cell module in an embodiment of the present invention. The solar cell module 722 includes one or more solar cells 724 and electrical connections 730, through which the generated electricity is transmitted to other components, for example, to rechargeable batteries or main processing modules. In some embodiments, the electrical line 730 may be connected to boost circuits, for example, to “step up” the output voltage from the solar cells 724. The exemplary solar cell module shown in the figure further includes a processing unit 728 such as a microcontroller and a display unit 726 containing, for example, an LCD screen or LED lights. In at least one embodiment of the present invention, the microcontroller 728 is used to measure the instantaneous power generated from solar cells 724. The measured power level may be transmitted to the main processing unit for further processing, or it may be displayed on display 726. The LCD display screen may also be used for other purposes, for example, for displaying diagnostic information regarding the operation of solar cells 724 or microcontroller 728. In some embodiments, the module 722 is implemented on a single integrated circuit (IC) board. Boost converters may be included in the board as well.

FIG. 18A illustrates, in a cross sectional view, an exemplary instantaneous power indicator 762 using photochromic materials. A photochromatic material shows different colors, for example, depending on the light wavelengths and/or its intensities. Photochromaticity (and electrochromaticity) is described in literature including “Organic Photochromic and Thermochromic Compounds” edited by John C. Crano, et al. (Plenum Press, New York, 1999). The exemplary embodiment shown in the figure comprises five indicator “lights” 766 made of a photochromic material, which are placed on a substrate 768. These “lights” respond to sunlight by either glowing or by changing color (e.g., from a transparent material which has no apparent color to a material which has an apparent color such as green or red). The power indicator further includes a wedge-shaped “shade” made of a semi-opaque neutral density material such as material in a neutral density photographic filter. The upward direction in the drawing corresponds to the outward direction, that is, toward incoming sunlight when the device is properly positioned. The wedge-shaped shade differentially limits the amount of sunlight hitting the “lights” or dots based upon the thickness of the shade over the particular dot. In this example, the photochromic dots in the right-hand direction will be more likely to react to the incoming light than the ones in the left-hand direction. Therefore, based on how many dots have been “lighted”, the intensity of the incoming light can be indicated. In some embodiments, a different shape of shade other than a wedge may be used. For example, a slab-like filter may be used (e.g., in place of 764) whose opacity changes gradually from one end to the other.

FIG. 18B shows a cross sectional view of another exemplary instantaneous power indicator 770 according to an embodiment of the present invention. In this exemplary embodiment, electrochromic materials are used instead, which tend to react differently to different electricity levels. For instance, certain electrochromic materials change colors depending on the electric voltage or current levels. As in the example of FIG. 18A, the dots 772 made of an electrochromic material are placed on a substrate 774. This module is then coupled to solar cells. For example, this power indicator can be attached to outgoing electrical lines (e.g., 730 of FIG. 17). Then, depending on the strength of the transmitted electrical current, the number of dots reacting will be different, thereby indicating the power level generated by the solar cells. This can be achieved, for example, by connecting different dots to the transmission line with resistors of different resistances. In certain embodiments, the electric current/voltage level is converted into a signal comprising multiple levels (e.g., through analog-to-digital converter) and the array of electrochromic dots is electrically controlled based on the converted signal (e.g., using an explicit circuitry). For example, when a signal is lower than a first preset value, none of the dots are “lighted”, and when a signal is between the first and a second set values, only the rightmost dot is lighted, and so forth. In some embodiments, only one dot made of photochromic or electrochromic materials may be used for this purpose. In those embodiments, various shades of different colors (or, different shades of gray, etc.) of the dot may be used, for example, to indicate the instantaneous power level.

It should be noted that the instantaneous power level (e.g., as used in connection with FIGS. 15-18) may not represent truly “instantaneous” value of the power generated by the solar cells. In embodiments of FIGS. 18A and 18B, for example, the photochromic and electrochromic materials may respond to stimulus with certain time delay. Therefore, any “instantaneous” indicator level may be an average over a certain time period which may be related to the time constants of the photochromic or electrochromic materials. In embodiments shown in FIG. 17, the same holds true. In at least one embodiment of the present invention, the instantaneous power level shown in the LCD screen 726 of FIG. 17, for example, will be an average over a certain time period, with the average being done by microcontroller 728, for example. In such an embodiment, the time period may be configurable, e.g., through the microcontroller.

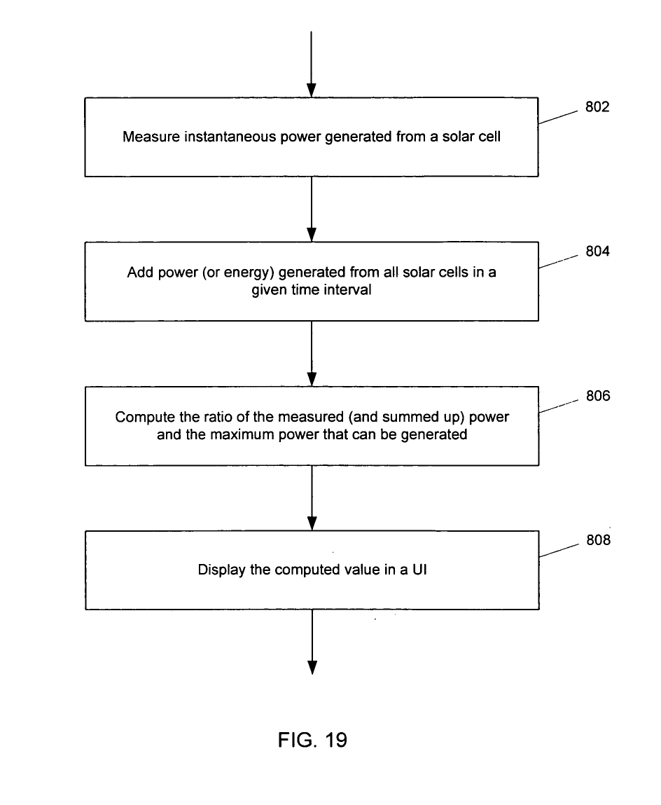

FIG. 19 is a flow chart illustrating an exemplary process for displaying instantaneous power levels according to an embodiment of the present invention. This process can be embodied, for example, as an instruction set executable by microcontroller 728 of FIG. 17. The exemplary method shown in FIG. 19 starts by measuring electrical power or current level generated from solar cells, as indicated in block 802. The energy or current is measured over a preset time period, at 804, and it is converted to certain values or ratios that can be more easily understood by users, at 806. For example, the actual energy generated during the preset time period may be divided by a theoretical and/or practical maximum possible value, thereby producing a value or ratio on a convenient scale. Then, the generated value is displayed to the user, for example, in the LCD display 726 of FIG. 17, as indicated in block 808. In some embodiments, this value is visually presented using a UI (user interface) similar to those shown in FIGS. 15-18.

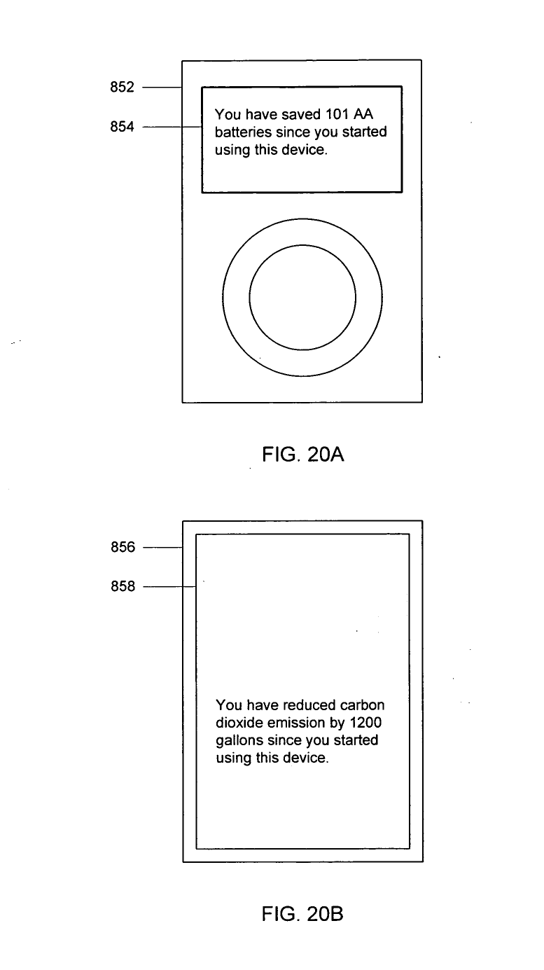

Referring now to FIGS. 20A and 20B, exemplary user interfaces for displaying “environmentally friendly” messages are illustrated. One of the benefits of using renewable energies such as solar power is they are “clean” and “earth-friendly”. Products based on solar power can appeal to many environmentally conscious consumers. Certain embodiments of the present invention address this aspect of using solar cells on portable devices. FIG. 20A shows a front side of a portable device 852, which is equipped with solar cells (not shown in the figure). In the main screen 854, a message representing the cumulative solar energy generated by the solar cells (e.g., since starting to use the device, or from a certain preset point in time) is shown. The message may be displayed in response to the user's action, or based on certain preset conditions. In this particular example, the message indicates the number of AA batteries equivalent to the cumulative energy generated by the solar cells on the device. This number can be computed, for example, by dividing the total cumulative energy (say, in Watt-hours) by the typical energy content (say, in Watt-hours) of an AA battery. Different types of AA batteries will have different amounts of stored energy, and the “environmentally friendly messages” containing these converted values are not intended to be accurate representations of the actual energy generated. FIG. 20B illustrates a different environmentally friendly message in accordance with at least one embodiment of the present invention. In this drawing, the message is displayed on top of solar panel 858, which is embedded on the backside of a portable data processing system 856. In this example, the message indicates the amount of carbon dioxide emission that has been reduced thanks to the use of the solar cells. In an embodiment, this number is calculated by computing the amount of coal (or petroleum) that needs to be burnt in order to produce the equivalent amount of energy that has been generated by the solar cells on the device. Then, the cumulative energy value can be converted to the amount of the carbon dioxide gas that could have been generated if the coal (or petroleum) has been burnt.

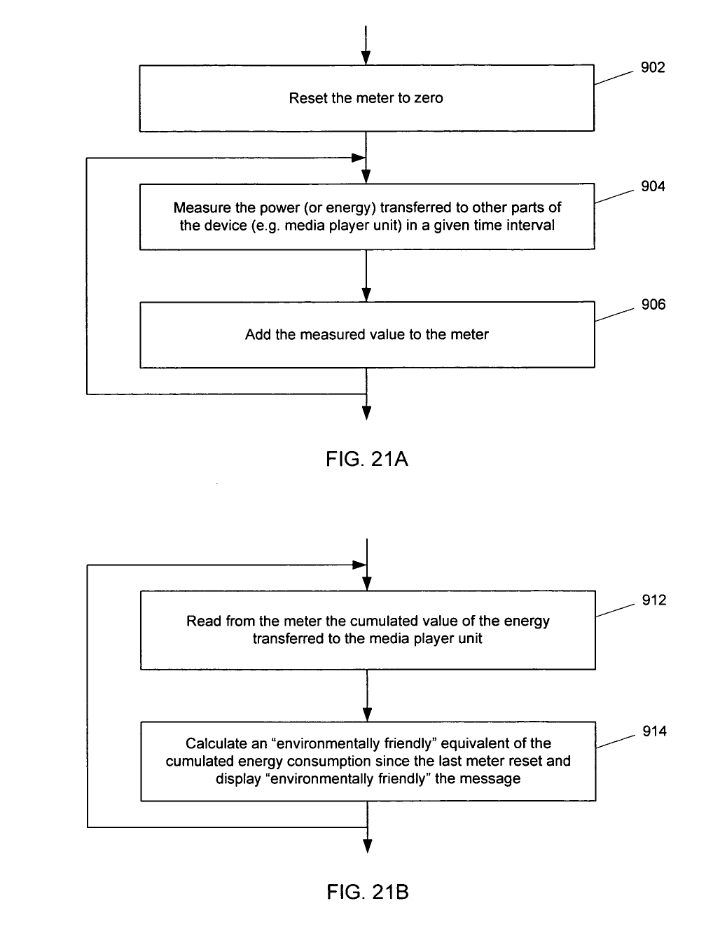

This process is illustrated as flow charts in FIGS. 21A and 21B according to certain embodiments of the present invention. In FIG. 21A, a flow chart illustrating an exemplary process for accumulating solar energy values generated from solar cells is shown. In the beginning of this exemplary process, a meter or a counter is initialized, at block 902. Next, the solar energy generated in a given time interval is measured, at 904, and added to the meter, at 906. These operations are then repeated. In some embodiments, the meter can be reset to zero in response to the user's actions or based on other system settings. The recorded energy value is then displayed to the user as shown in the flow chart of FIG. 21B, in which an exemplary process for displaying environmentally friendly messages such as those shown in FIGS. 20 is illustrated. This process can be triggered in response to the user's explicit actions or other events such as timer events. In operation 912, the cumulative energy value is read from the meter/counter such as the one used in a process shown in FIG. 21A. Then, the energy value is converted to one or more “environmentally friendly values” at block 914. As illustrated earlier, the environmentally friendly values include the number of AA batteries or the amount of carbon dioxide gas, or any values meaningful to the end users. Then, the environmentally friendly message is generated based on these “user-friendly values” and it is displayed in a user interface 914.

Thus, methods, systems, structures, and apparatuses for using solar cells with portable devices have been provided. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for arranging and connecting a plurality of solar cells on a portable device, each solar cell configured to have a voltage output when activated, the method comprising:
connecting the plurality of solar cells so that a combined voltage output of the plurality of solar cells, when all solar cells from the plurality of solar cells are activated, is substantially close to a preset voltage value; and
arranging the plurality of solar cells on the portable device so that said preset voltage is maintained if a substantial fraction of solar cells from the plurality of solar cells are activated.

2. The method of claim 1, wherein:
said connecting comprises at least one of:
(a) connecting in series at least one first solar cell from the plurality of solar cells and at least one second solar cell from the plurality of solar cells; and
(b) connecting in parallel at least one third solar cell from the plurality of solar cells and at least one fourth solar cell from the plurality of solar cells, wherein said at least one third solar cell and said at least one fourth solar cell have the same voltage output when activated.

3. The method of claim 1, wherein:
said connecting comprises connecting in parallel a first set of solar cells from the plurality of solar cells and connecting in parallel a second set of solar cells from the plurality of solar cell and connecting in series said first set of solar cells and said second set of solar cells.

4. The method of claim 1, wherein:
said arranging comprises arranging the plurality of solar cells in an alternating pattern.

5. The method of claim 1, wherein:
the device has a first side and a second side, wherein a main display of the device is located on said first side, and said arranging comprises placing a substantial fraction of solar cells from the plurality of solar cells on said second side.

6. A portable data processing system, comprising:
a processing system;
a memory coupled to the processing system;
a set of solar cells coupled to the processing system, the set of solar cells including a first group of solar cells having at least one solar cell and a second group of solar cells having at least one solar cell, each group of solar cells coupled in series with the processing system and the memory to provide power to the processing system and the memory, the first group of solar cells capable of providing sufficient power to the processing system and the memory when the second group of solar cells is at least partially obstructed, and the second group of solar cells capable of providing sufficient power to the processing system and the memory when the first group of solar cells is at least partially obstructed.

7. A portable data processing system as in claim 6, wherein:
the first group of solar cells and wherein the second group of solar cells are coupled in parallel and wherein solar cells in the first group of solar cells are coupled in series and wherein solar cells in the second group are coupled in series and wherein the set of solar cells are disposed on at least one surface of the portable data processing system and wherein the portable data processing system comprises a media player to play media stored in the memory.

8. A portable data processing system as in claim 6, wherein:
the first group of solar cells has only one solar cell and the second group of solar cells has only one solar cell.

9. A portable data processing system as in claim 7, wherein:
the first group of solar cells and the second group of solar cells are arranged in an alternating pattern on the at least one surface, the alternating pattern designed to reduce the probability that both of the first group of solar cells and the second group of solar cells are concurrently obstructed.

10. A portable data processing system as in claim 7, wherein:
the first group of solar cells is on a first surface of the data processing system and the second group of solar cells is on a second surface of the data processing system, the first surface comprising a display and a user input device and the second surface is a back panel of the data processing system.

11. A portable data processing system as in claim 9, further comprising:
a display device disposed on the at least one surface, the display device displaying an amount of power produced by at least one of the first group of solar cells and the second group of solar cells.

12. A portable data processing device, comprising:
a frame;
a processor coupled to the frame;
a solar cell layer coupled to the processor; and
a shock-absorbing material coupling the solar cell layer to the frame, the solar cell to provide power to the processor.

13. The device of claim 12, wherein:
the frame is comprised of at least one of
(a) a metallic material; and
(b) a graphite.

14. The device of claim 12, further comprising:
at least one glass layer coupled to the solar cell layer; and
a flexible printed circuit board (PCB) layer coupled electrically and mechanically to the solar cell layer.

15. The device of claim 14, wherein:
said at least one glass layer is anti-reflection coated.

16. The device of claim 12, wherein:
the processor is coupled to a memory which is to store media and wherein the processor is configured to play media stored on the memory.

17. The device of claim 14, wherein:
at least one surface of the at least one glass layer is substantially flush with an outer edge of the frame.

18. The device of claim 14, wherein:
the at least one glass layer is etched with a pattern which identifies at least one of a product or a company.

19. The device of claim 12, further comprising:
a display layer, said display layer being substantially semi-transparent to a wavelength of light, wherein at least one solar cell in said solar cell layer is substantially sensitive to said wavelength of light.

20. The device of claim 19, wherein:
said display layer is configured to display at least one of
(a) information regarding status of at least one solar cell from the plurality of solar cells; and
(b) information related to the use of the device.

21. The device of claim 19, further comprising:
a touchpad layer, said touchpad layer coupled to said display layer and said touchpad layer being substantially semi-transparent to a wavelength of light, wherein at least one solar cell in said solar cell layer is substantially sensitive to said wavelength of light.

22. The device of claim 21, wherein:
said touchpad layer is configured to receive input for the device.

23. A method for displaying instantaneous power output from a solar cell on a portable data processing device, the solar cell having a maximum power output, wherein the solar cell is attached to a first side of the data processing device, the method comprising:
measuring an instantaneous power output from the solar cell;
computing a ratio between the measured instantaneous power output and the maximum power output; and
displaying the ratio on the first side of the device, wherein a second side of the data processing device comprises a display and a user input device.

24. The method of claim 23, wherein:
said displaying comprises at least one of
(a) displaying on a main display of the device;
(b) displaying using a set of LEDs, wherein said set of LEDs are configured to be selectively turned on so that the ratio corresponds to the number of LEDs turned on; and
(c) displaying on an LCD display, wherein said LCD is coupled to the solar cell.

25. A portable data processing device, comprising:
a processor coupled to a memory;
a solar cell, the solar cell having a maximum power output, the solar cell disposed on a surface of the data processing device; and
a display to display an instantaneous power output, the display being disposed on the surface.

26. The device of claim 25, wherein:
said memory is configured to store media for presentation to a user.

27. The device of claim 25, wherein:
the display comprises at least one of
(a) an electrochromic material;
(b) a liquid crystal material; and
(c) a photochromic material.

28. A method for displaying a cumulative power output from a solar cell, the method comprising:
measuring a power output from a solar cell;
recording cumulatively said power output for a substantial period of time;
converting the recorded power output for said substantial period of time into an environmentally friendly value;
generating an environmentally friendly message using the environmentally friendly value; and
displaying the environmentally friendly message.

29. The method of claim 28, wherein:
said environmentally friendly value comprises a number of batteries corresponding to the recorded cumulative power output.

30. The method of claim 28, wherein:
said displaying comprises at least one of
(a) displaying substantially close to the solar cell; and
(b) displaying on a main display of a device, wherein said device is coupled to the solar cell.

31. An apparatus for use on a portable device, the device comprising a processor and a memory, wherein the memory is coupled to the processor, the apparatus comprising:
a solar cell, said solar cell coupled to the device;
means for measuring an energy transferred to the device, wherein said energy is generated from said solar cell; and
means for communicating the measured energy value to the processor.

32. The apparatus of claim 31, wherein:
the device further comprises means to display and said means to display is configured for displaying the measured cumulative energy value.

33. The apparatus of claim 32, wherein:
said displaying comprises displaying an environmentally friendly message corresponding to the measured cumulative energy value.

34. A portable media player, comprising:
an enclosure having a total exterior surface area of less than about 30,000 mm²;
a media processing system disposed within the enclosure;
an input device disposed on the exterior surface of the enclosure, the input device coupled to the media processing system to select media, stored on a storage device which is coupled to the media processing system and which is disposed within the enclosure, for presentation;
a battery coupled to the media processing system and to the storage device and to the input device; and
a solar energy device coupled to at least one of the battery, the media processing system, the storage device, and the input device, the solar energy device being an integral part of the enclosure and being disposed on at least one exterior surface of the enclosure.

35. The portable media player of claim 34, wherein:
the solar energy device converts light to electrical power to provide electrical power to at least one of the battery, the media processing system, the storage device, and the input device, and wherein the total exterior surface area is less than about 10,000 mm², and wherein the media presented by the portable media player comprises music.

36. The portable media player of claim 35, wherein:
the solar energy device comprises a plurality of separate cells configured to provide power even if a subset of the plurality of separate cells are prevented from capturing light.

37. A portable media player, comprising:
an enclosure having an exterior surface;
a media processing system disposed within the enclosure;
an input device disposed on the exterior surface of the enclosure, the input device coupled to the media processing system to select media, stored on a storage device which is coupled to the media processing system and which is disposed within the enclosure, for presentation;
a battery coupled to the media processing system and to the storage device and to the input device to provide power;
a solar energy device coupled to at least the battery to recharge the battery, the solar energy device being an integral part of the enclosure; and
a shock absorbing material coupling the solar energy device to the enclosure.

38. The portable media player of claim 37, wherein:
the solar energy device comprises a plurality of separate cells configured to provide power even if a subset of the plurality of separate cells are prevented from capturing light.

39. A portable data processing system, comprising:
a base unit having an input device;
a display unit coupled to said base unit, said display unit having a first side and a second side, wherein said second side includes at least one of (a) a product logo, or (b) a company logo;
a display screen deposited on said first side of said display unit; and
a solar panel deposited on said second side of said display unit.

40. The portable data processing system of claim 39, wherein:
said solar panel is used to supply electrical power to the portable data processing system when the portable data processing system is exposed to ambient light.

41. The portable data processing system of claim 39, wherein:
said display unit is rotatably coupled to said base unit so that said display unit may be either in a closed position or in an open position.

42. The portable data processing system of claim 41, wherein:
said second side of said display unit is exposed when said display unit is in said closed position.

43. The portable data processing system of claim 39, wherein:
said display screen is at least one of (a) LCD display, or (b) plasma display.

44. The portable data processing system of claim 39, wherein:
said solar panel is attached to said display unit using a shock absorbing material.

45. The portable data processing system of claim 39, wherein:
said solar panel comprises a plurality of solar cells.
